(19) United States
(12) Patent Application Publication
(10) Pub. No.: US 2019/0308543 A1
(43) Pub. Date: Oct. 10, 2019

(54) LOADING FLOOR ARRANGEMENT FOR A LOAD SPACE OF A MOTOR VEHICLE

(71) Applicants: Jürgen SALEWSKI, Rochester Hills, MI (US); Bill POMPILI, Shelby Township, MI (US); Ed STEINMETZ, Lapeer, MI (US); Everardo HERNANDEZ, Shelby Township, MI (US)

(72) Inventors: Jürgen SALEWSKI, Rochester Hills, MI (US); Bill POMPILI, Shelby Township, MI (US); Ed STEINMETZ, Lapeer, MI (US); Everardo HERNANDEZ, Shelby Township, MI (US)

(21) Appl. No.: 16/373,030

(22) Filed: Apr. 2, 2019

Related U.S. Application Data
(60) Provisional application No. 62/652,512, filed on Apr. 4, 2018.

(51) Int. Cl. B60P 1/00; B60R 5/04; B65G 67/04

(52) U.S. Cl. CPC B60P 1/00; B65G 67/04; B60R 5/04

(57) ABSTRACT

Loading floor arrangement for a load space of a motor vehicle with a loading floor mounted for movement between a rest position and an extended position, and with an adjustment device for displacement of the loading floor between the rest position and the extended position. The adjustment device has a guide rail arrangement fixed to the vehicle with a guide portion extending longitudinally in the load space, at least one lift guide portion extending in the load space height direction, and at least one guide body assigned to the loading floor and guided so as to be slidingly movable relative to the longitudinal guide portion and the lift guide portion. A control slide is mounted so as to be movable relative to the guide portion and is provided with a control curve which cooperates by forced guidance with the guide body such that the loading floor can be moved between the rest position and the extended position depending on a longitudinal displacement of the control slide.

### CROSS-REFERENCE TO RELATED APPLICATIONS

This claims priority from U.S. Provisional Application No. 62/652,512, filed Apr. 4, 2018, the disclosure of which is hereby incorporated by reference in its entirety into this application.

### RELATED FIELD

The invention concerns a loading floor arrangement for a load space of a motor vehicle, with a loading floor which is mounted so as to be movable between a rest position and an extended position, and with an adjustment device for moving the loading floor between the rest position and the extended position, wherein in the extended position, the loading floor is raised relative to the rest position and is longitudinally displaced towards the rear beyond a rear load space access edge.

### BACKGROUND

Such a loading floor arrangement is known from DE 197 31 324 A1. The known loading floor arrangement has a loading floor mounted on rollers in a supporting rail system. The supporting rail system can be displaced by means of parallelogram links between a lower rest position and an upper raised position. The parallelogram links forming the parallelogram link system are displaced via a telescopically extendable actuating cylinder which is driven pneumatically or hydraulically. As soon as the supporting rail system has been moved into its upper raised position by means of the parallelogram link system, the loading floor can be pushed back in the vehicle longitudinal direction along the supporting rails by means of its rollers, whereby the loading floor partially protrudes out of the vehicle beyond a rear loading floor access edge.

### SUMMARY

The object of the invention is to create a loading floor arrangement of the type cited initially which allows a functionally reliable displacement of the loading floor between the rest position and the extended position using particularly simple means.

This object is achieved in that the adjustment device comprises a guide rail arrangement fixed to the vehicle, with a longitudinal guide portion extending in the load space longitudinal direction, and with at least one lift guide portion extending in the load space height direction, and at least one guide body assigned to the loading floor and guided so as to be slidingly movable relative to the longitudinal guide portion and the lift guide portion, and a control slide mounted so as to be longitudinally movable relative to the longitudinal guide portion and provided with a control curve which cooperates by forced guidance with the guide body of the loading floor such that the loading floor can be moved between the rest position and the extended position depending on a longitudinal displacement of the control slide. The purely sliding movability of the guide bodies of the loading floor allows a particularly simple linear guidance which has low wear but nonetheless allows reliable function. The guide rail arrangement fixed to the vehicle, and the control slide mounted so as to be exclusively longitudinally movable, guarantee a simple and robust structure which is quick to install and has little susceptibility to wear. Particularly advantageously, the solution according to the invention is suitable for a load space in a vehicle interior of the car. Alternatively, the loading floor arrangement according to the invention may also be used for other types of motor vehicles used on land, in the air or on water.

The loading floor is advantageously made of one piece and dimensionally stable. The at least one guide body is preferably provided in the region of an underside of the loading floor and is fixedly connected to the loading floor or molded integrally onto the loading floor. The at least one guide body advantageously protrudes downward from an underside of the loading floor, approximately at right angles. The terms “bottom”, “top”, “rear”, “front” and “side” used in the context of the invention relate to a vehicle coordinate system of the load space, wherein this coordinate system itself corresponds to a coordinate system of the motor vehicle, so that a load space longitudinal direction and a load space height direction coincide with a vehicle longitudinal direction and a vehicle height direction. Accordingly, a load space transverse direction also corresponds to a vehicle transverse direction.

In the embodiment of the invention, the control curve is formed by at least one control ramp designed on the principle of an oblique plane, wherein the at least one guide body has a run-up chamfer which is complementary to the control ramp. Preferably, a corresponding angle of the control ramp and a complementary angle of the run-up chamfer form an angle of 45° relative to the load space coordinate system. The run-up chamfer of the guide body easily slides along the oblique plane of the control ramp. In order to facilitate corresponding lift forces for an upward sliding movement of the at least one guide body along the control ramp in the height direction, it is advantageously provided that the control ramp and the complementary run-up chamfer have an acute angle of less than 45°, preferably between 10° and 30°, relative to a horizontal of the load space coordinate system. This creates a flatter lift of the guide body relative to the control slide.

In a further embodiment of the invention, the control slide has a supporting portion for mounting in a slidingly movable fashion on the longitudinal guide portion of the guide rail arrangement. The control slide may advantageously have at least one laterally protruding supporting web which engages in a complementary guide groove forming the longitudinal guide portion. Alternatively, the supporting portion may be configured as a support groove open to one side, and the longitudinal guide portion of the guide rail arrangement is configured in correspondingly complementary fashion as a longitudinal guide web engaging in the support groove.

In a further embodiment of the invention, the at least one guide body has a sliding support for longitudinally movable guidance in the lift guide portion or the longitudinal guide portion of the guide rail arrangement. Particularly advantageously, this sliding support serves to guide the guide body so as to be linearly movable in the height direction inside the lift guide portion and in the longitudinal direction inside the longitudinal guide portion. The lift guide portion opens into the longitudinal guide portion. The forced guidance of the sliding support by the lift guide portion is necessarily eliminated in the corresponding opening region, whereby the sliding support moves further in linear fashion along the longitudinal guide portion.

In a further embodiment of the invention, a drive system is provided to move the control slide in the longitudinal direction. According to the invention, the adjustment device may be actuated either manually or by a drive system. According to the present embodiment, a drive system is provided which has at least one mechanical, electrical, pneumatic or hydraulic drive motor. Preferably, the drive system is configured such that it activates the adjustment device in both directions, i.e. in the direction of the extended position and back in the direction of the rest position. Alternatively, it is possible that the drive system is active in only one direction and movable manually in the opposite direction.

In a further embodiment of the invention, two control slides are provided in the region of opposite longitudinal sides of the load space, wherein each control slide cooperates with two guide bodies of the loading floor provided in side regions of the loading floor. Here, the loading floor is supported in the region of opposite longitudinal sides of the load space. In each corresponding opposite side region, preferably provided on the underside of the loading floor, the loading floor comprises two guide bodies which are spaced apart from each other in the load space longitudinal direction. The respective control slide acts as a forced guide on the two guide bodies of each side of the loading floor, wherein the respective control slide is mounted so as to be longitudinally displaceable in a respective guide rail, which is fixed to the vehicle and comprises a longitudinal guide portion and two lift guide portions spaced apart from each other correspondingly to the guide body. For each guide body, the control slide has a control ramp on the principle of an oblique plane, wherein each guide body also has a complementary run-up chamfer.

In a further embodiment of the invention, the drive system has a synchronizing device to achieve synchronous longitudinal displacement of the two control slides. Preferably, the drive system is provided with two drive transmission cables, advantageously in the form of twisted cables, which are driven in synchrony with each other via a common electric motor. Each drive transmission cable is fixedly connected to one of the two control slides and drives the control slide forward and backward in the longitudinal direction.

### BRIEF DESCRIPTION OF THE DRAWINGS

Further advantages and features of the invention arise from the claims and from the following description of a preferred exemplary embodiment of the invention which is shown in the drawings.

FIG. 1 shows diagrammatically a rear region of a car with an embodiment of a loading floor arrangement according to the invention for a load space of the car, with a loading floor in its rest position,

FIG. 2 shows the car from FIG. 1 but with the loading floor moved into its extended position,

FIG. 3 depicts diagrammatically the loading floor arrangement according to FIGS. 1 and 2 in perspective view, with the omission of the load space environment, with the loading floor in a rest position,

FIG. 4 illustrates the loading floor arrangement according to FIG. 3 with the loading floor in a raised position,

FIG. 5 depicts the loading floor arrangement according to FIGS. 3 and 4 with the loading floor in an extended position,

FIG. 6 shows a loading floor arrangement according to FIGS. 3 to 5 in a perspective, exploded view,

FIG. 7a depicts diagrammatically in a side view the loading floor arrangement from FIG. 3 in the rest position,

FIG. 7b shows an extract of the loading floor arrangement from FIG. 7a,

FIG. 8a illustrates diagrammatically, in a side view, the loading floor arrangement according to FIG. 4 in the raised position,

FIG. 8b shows an extract of the loading floor arrangement from FIG. 8a,

FIG. 9a depicts, in a diagrammatic, side view, the loading floor arrangement from FIG. 5 in the extended position, and

FIG. 9b shows an extract of the loading floor arrangement according to FIG. 9a.

### DETAILED DESCRIPTION

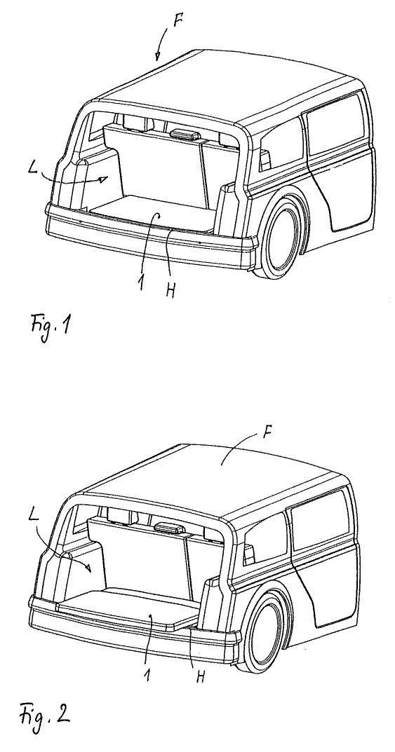

According to FIGS. 1 and 2, in a rear region, a car F has a load space L which is part of a vehicle interior of the car F. The load space L is delimited at the front in the vehicle longitudinal direction by a backrest arrangement of a rear seat. Towards opposite vehicle sides, the load space L is delimited by two load space side regions. At the back in the vehicle longitudinal direction, a rear body part (not shown) is provided which, in the exemplary embodiment according to FIGS. 1 and 2, is designed as a tailgate mounted in a roof region of the car F so as to be movable by pivoting about a pivot axis extending in the vehicle transverse direction. In the depictions according to FIGS. 1 and 2, the tailgate has been half removed for greater clarity. A corresponding rear opening for the load space L, which can be closed by the tailgate, is delimited in the region of its underside by a rear load space access edge H extending in the vehicle transverse direction.

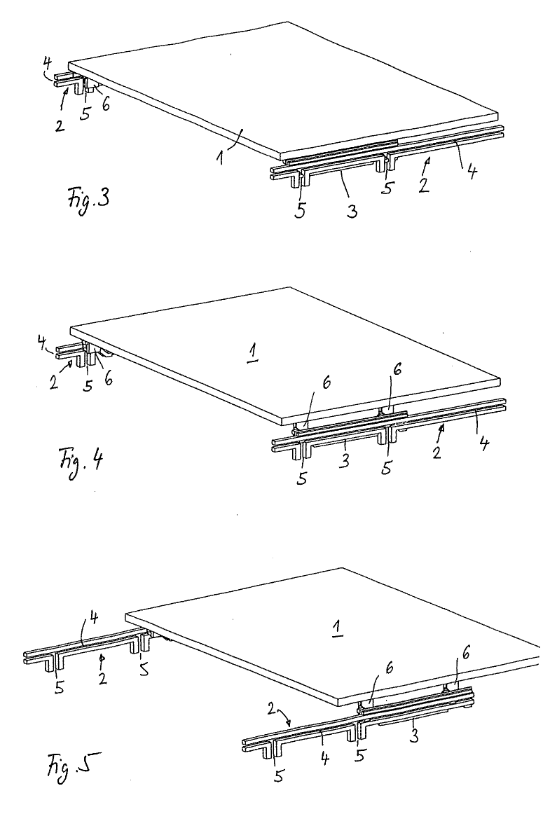

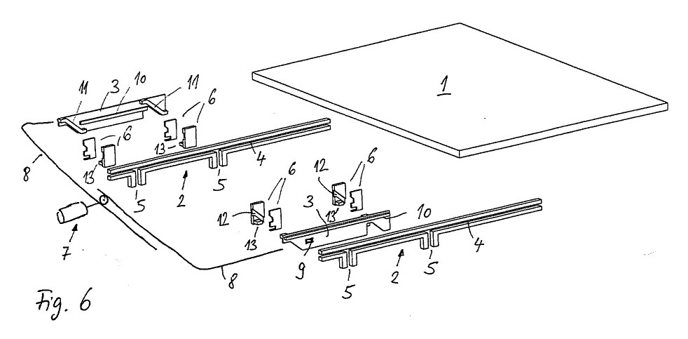

In a floor region of the load space L, a loading floor arrangement is provided with a loading floor 1 which can be moved between a rest position (FIG. 1) and an extended position (FIG. 2). The loading floor arrangement is explained in more detail below with reference to FIGS. 3 to 9b.

The loading floor 1 is designed to be dimensionally stable in the form of a platform, and has a base which is at least substantially rectangular. The loading floor 1 is mounted so as to be movable between the rest position and the extended position by means of an adjustment device which will be described in more detail below. FIGS. 3 to 6 show the loading floor arrangement obliquely from the front, so that on the drawings, a left-hand edge of the loading floor 1 extending in the vehicle transverse direction forms a front edge, and a right-hand edge lying opposite this in the drawings forms a rear edge which, in the extended position of the loading floor 1, protrudes to the rear out of the rear opening of the load space L beyond the rear load space access edge.

In the region of its underside, in opposite side regions, the loading floor 1 comprises in each case two guide bodies 6 which are attached to or integrally molded onto the underside of the loading floor 1 and which protrude orthogonally downward relative to the underside of the loading floor 1. The two guide bodies 6 on the opposite side regions of the loading floor 1 are spaced apart from each other in the load space longitudinal direction, wherein both guide bodies 6 are situated in a front half of the underside of the loading floor 1. Consequently, in the extended position, a rear half of the loading floor 1 protrudes rearwardly and freely beyond the rear load space access edge H towards the outside of the car F. Each guide body 6 is configured as a dimensionally stable block body and is formed in two pieces. A function part of each guide body 6 has a guide groove 12 serving as a run-up chamfer and running obliquely at an angle of around 45°. Each function part of each guide body 6 is also provided with a sliding support 13 which protrudes outwardly at right angles in the vehicle transverse direction and is formed as a cam. The other part of each guide body 6 forms a cover part.

The two guide bodies 6 of each side region of the loading floor 1 are connected in slidingly movable fashion to a respective control slide 3 which is provided with two control ramps 11 running parallel to each other in the manner of an oblique plane. In the region of their top side and in the region of their underside, the control ramps 11 transform into horizontal end portions. The control ramps 11 are molded integrally onto the control slide 3. The control slide 3 has an at least largely flat platform oriented in the height direction and in the vehicle longitudinal direction, and is designed to be dimensionally stable. The control ramps 11 are designed so as to be complementary to the guide grooves 12, so that the control ramps 11 engage by forced guidance in slidingly movable fashion in a respective guide groove 12 of the function part of the respective guide body 6. The control ramps 11 consequently also have an angle 45° to a horizontal.

The two control slides 3 are each mounted in a guide rail arrangement 2 so as to be linearly movable in the load space longitudinal direction. Each guide rail arrangement 2 is fixed to the load space and hence fixed to the vehicle in one of the two load space side regions. The two guide rail arrangements 2 are connected in a crash-resistant fashion to a body supporting structure of the car F. Each guide rail arrangement 2 has a longitudinal guide portion 4 which extends over the entire length of the load space L, and which is rectilinear and elongate in the load space longitudinal direction. Each longitudinal guide portion 4 is designed as a guide groove or block guide. The respective control slide 3 is guided so as to be longitudinally movable in its longitudinal guide portion 4 by means of a sliding guide web 10 which forms a supporting portion in the sense of the invention. The sliding guide web 10, facing a vehicle center and hence the load space center, extends between the two control ramps 11 of the respective control slide 3.

Each guide rail arrangement 2 also has two assigned lift guide portions 5 which protrude downward at right angles from the respective longitudinal guide portion 4 and open into the respective longitudinal guide portion 4. The two lift guide portions 5 of each guide rail arrangement 2 consequently extend in the load space height direction, i.e. in the vehicle height direction. The two lift guide portions 5 of each guide rail arrangement 2 are arranged spaced apart from each other in the load space longitudinal direction by a distance corresponding to the spacing of the two guide bodies 6 of each side region of the load space 1. A sliding support 3 of each guide body 6 is mounted in each lift guide portion 5 so as to be slidingly movable in the height direction.

The two control slides 3 are driven by means of a drive system so as to be linearly movable in both directions along the longitudinal guide portions 4 of the two guide rail arrangements 2. For this, the drive system comprises two flexible drive transmission cables 8 which each act on a contact point 9 on the respective control slide 3 and which are longitudinally movable by means of a central electric drive motor 7 and a suitable gear mechanism. In the exemplary embodiment shown, the drive transmission cables 8 are configured as twisted cables which are guided so as to be longitudinally movable in guide channels (not shown) positioned fixedly in the load space. The drive motor 7 can be controlled by an electronic control unit and is supplied with power by an electric on-board vehicle network.

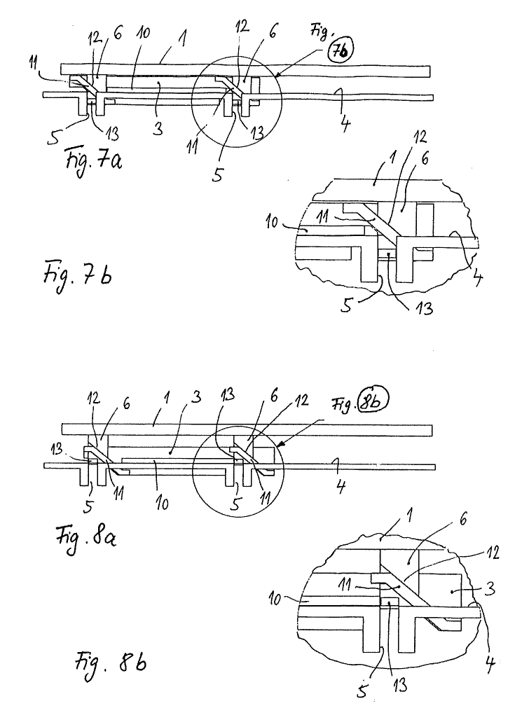

The function of the loading floor arrangement is described in more detail below with reference to FIGS. 7a to 9b. FIGS. 7a and 7b show the rest position of the loading floor 1. In this rest position, the sliding supports 13 of the guide bodies 6 are force-guided in the height direction in the lift guide portions 5 of the guide rail arrangement 2. At the same time, the run-up chamfers 12 of the guide body 6 are securely held on the control slide 3 by the control ramps 11 and consequently are also force-guided. On a rearward movement of the control slide 3 in the vehicle longitudinal direction, i.e. to the right in the drawings, the control ramps 11 are also moved rearward from the position shown in FIGS. 7a and 7b, whereby necessarily the guide bodies 6, which are force-guided in the height direction, are moved upward by the run-up chamfers 12 sliding along the control ramps 11.

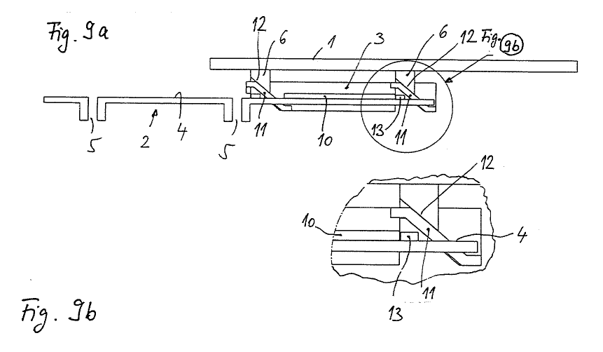

As soon the loading floor 1 has reached its raised position shown in FIGS. 8a and 8b, the sliding supports 13 of the guide bodies 6 protrude upward out of the lift guide portions 5 of the guide rail arrangements 2. The sliding supports 13 are now aligned with the longitudinal guide portions 4 of the guide rail arrangements 2. Consequently, a continued drive of the control slides 3 towards the rear in the vehicle longitudinal direction necessarily leads to the sliding supports 13 being carried along the longitudinal guide portions 4, whereby necessarily also the guide bodies 6 and consequently the loading floor 1 in the raised position are moved towards the back in the vehicle longitudinal direction. An end stop (not shown) limits a longitudinal movement of the control slides 3 towards the rear in the load space longitudinal direction. This longitudinal displacement in the raised position (FIGS. 9a and 9b) necessarily causes the rear half of the loading floor 1 to move outward beyond the rear load space access edge towards an outside of the car F.

In order to return the loading floor 1 from the extended position to its rest position, the control slides 3 are simply driven in the opposite direction, whereby the corresponding movement processes described above are simply reversed. The two control slides 3 are moved in synchrony with each other by means of the drive system.

1. Loading floor arrangement for a load space of a motor vehicle, with a loading floor which is mounted so as to be movable between a rest position and an extended position, and with an adjustment device for moving the loading floor between the rest position and the extended position, wherein in the extended position, the loading floor is raised relative to the rest position and is longitudinally displaced towards the rear beyond a rear load space access edge, wherein the adjustment device
has a guide rail arrangement fixed to the vehicle with a longitudinal guide portion extending in the load space longitudinal direction, and with at least one lift guide portion extending in the load space height direction,
and at least one guide body assigned to the loading floor and guided so as to be slidingly movable relative to the longitudinal guide portion and the lift guide portion,
and a control slide mounted so as to be longitudinally movable relative to the longitudinal guide portion and provided with a control curve which cooperates by forced guidance with the guide body of the loading floor such that the loading floor can be moved between the rest position and the extended position depending on a longitudinal displacement of the control slide.

2. Loading floor arrangement according to claim 1, wherein the control curve is formed by at least one control ramp designed on the principle of an oblique plane, wherein the at least one guide body has a run-up chamfer which is complementary to the control ramp.

3. Loading floor arrangement according to claim 1, wherein the control slide has a supporting portion for mounting in a slidingly movable fashion on the longitudinal guide portion of the guide rail arrangement.

4. Loading floor arrangement according to claim 1, wherein the at least one guide body has a sliding support for longitudinally movable guidance in the lift guide portion or the longitudinal guide portion of the guide rail arrangement.

5. Loading floor arrangement according to claim 1, wherein a drive system is provided to move the control slide in the longitudinal direction.

6. Loading floor arrangement according to claim 1, wherein two control slides are provided in the region of opposite longitudinal sides of the load space, wherein each control slide cooperates with two guide bodies of the loading floor provided in side regions of the loading floor.

7. Loading floor arrangement according to claim 5, wherein the drive system has a synchronizing device to achieve synchronous longitudinal displacement of the two control slides.
